(19) United States
(12) Patent Application Publication
(10) Pub. No.: US 2026/0008623 A1
(43) Pub. Date: Jan. 8, 2026

(54) CARRYING HANDLE FOR BAGGED FOOD ITEMS

(71) Applicant: Volk Enterprises, Inc., Turlock, CA (US)

(72) Inventor: Daniel J. Volk, Cumming, GA (US)

(73) Assignee: Volk Enterprises, Inc., Turlock, CA (US)

(21) Appl. No.: 18/762,918

(22) Filed: Jul. 3, 2024

(51) Int. Cl. B65G 7/12; B29C 45/00; B29L 31/46

(52) U.S. Cl. CPC B65G 7/12; B29C 45/0046; B29L 2031/463

(57) ABSTRACT

An improved carrying handle is provided for carrying bagged or shrink-wrapped food items such as whole-bodied turkeys, for example. The carrying handle can have increased strength, improvements in terms of facilitating carrying by a user and slide and twist prevention to prevent a clamping ring of the carrying handle from being forced off of the bag and/or from twisting relative to a neck portion of the bag or shrink wrap after the handle has been attached to the bag or shrink wrap.

### BACKGROUND OF THE INVENTION

### Technical Field

The present invention relates generally to a carrying handle for wrapped food items, such as whole-bodied turkeys, which have been shrink-wrapped with the shrink wrap being secured at one end with a retaining clip.

### Prior Art

In some cases, whole bodied turkeys are handled by simply grasping the sides of the shrink-wrapped carcass and lifting. This is less than satisfactory if the shrink wrap is wet because the carcass is often heavy and difficult to handle when the shrink wrap becomes damp. Another disadvantage to handling whole-bodied wrapped turkeys in this manner is that if one is dropped on another, the wrappings occasionally become torn, resulting in spoilage of the carcass.

To overcome these problems, a carrying handle was designed and manufactured for carrying shrink-wrapped whole-bodied turkeys. The carrying handle is applied to the wrapped food items such as whole-bodied turkeys by drawing an opening in the handle around the shrink wrapping at a point between the retaining clip and the food item. This allows a shopper to simply grip the carrying handle to easily carry the wrapped food item. Examples of such carrying handles are disclosed in U.S. Pat. Nos. 4,772,133 and 4,818,121.

While these carrying handles work well for their intended purposes, a need exists for an improved carrying handle for carrying bagged or wrapped food items.

### BRIEF SUMMARY OF THE INVENTION

Briefly described, the present disclosure is directed to a carrying handle for use in conjunction with food items that have been wrapped or bagged in an enclosure having an end that is closed with a retaining clip. The carrying handle taught herein has at least several advantages over the prior art.

In accordance with a representative embodiment, the carrying handle comprises first and second flexible arms and a clamping ring. The first and second flexible arms have proximal ends and distal ends. The proximal ends are joined together at a top end of the carrying handle to form a grip portion. The flexible arms arch outwardly away from one another at the grip portion of the carrying handle and then extend downwardly and inwardly toward one another at the distal ends. The clamping ring is joined to the distal ends of the first and second flexible arms and is configured to clamp about a neck portion of the enclosure near the retaining clip such that the retaining clip is located in between the end of the enclosure and the clamping ring. The clamping ring defines an inner space for receiving the neck portion of the enclosure. The clamping ring has an inner surface that comes into contact with the neck portion when the neck portion is received in the inner space defined by the clamping ring. The inner surface of the clamping ring has one or more protrusions thereon that grip an outer surface of the neck portion when the neck portion is within the inner space defined by the clamping ring.

In accordance with another representative embodiment, the carrying handle comprises first and second flexible arms, a strengthening element and a clamping ring. The first and second flexible arms have proximal ends and distal ends. The proximal ends are joined together at a top end of the carrying handle to form a grip portion. The flexible arms arch outwardly away from one another at the grip portion of the carrying handle and then extend downwardly and inwardly toward one another at the distal ends. The strengthening element is disposed on the top end of the carrying handle and comprises a region of increased thickness where the proximal ends of the first and second flexible arms are joined to form the gripping portion. The increased thickness increases a strength of the gripping portion of the carrying handle. The clamping ring is joined to the distal ends of the first and second flexible arms. The clamping ring is configured to clamp about a neck portion of the enclosure near the retaining clip such that the retaining clip is located in between the end of the enclosure and the clamping ring. The clamping ring defines an inner space for receiving the neck portion of the enclosure. The clamping ring has an inner surface that comes into contact with the neck portion when the neck portion is received in the inner space defined by the clamping ring.

In accordance with a representative embodiment, a method for making the carrying handle comprises providing a mold having a first region for forming a clamping ring at a bottom end of the carrying handle, second and third regions for forming first and second flexible arms, respectively, and a fourth region for forming a strengthening element at a top end of the carrying handle. The method further comprises injecting a fluid molding material into the first region such that the fluid molding material flows from the first region into the second and third regions and then flows from the second and third regions into the fourth region, wherein the strengthening element is formed where fluid molding material flowing from the second region into the fourth region comes into contact with fluid molding material flowing from the third region into the fourth region. The method further comprises curing the fluid molding material to convert the fluid molding material into hardened molding material.

In one embodiment, the invention is a carrying handle for use in conjunction with food items that have been wrapped or bagged in an enclosure having an end that is closed with a retaining clip, the carrying handle comprising first and second flexible arms having proximal ends and distal ends, the proximal ends being joined together at a top end of the carrying handle to form a grip portion, wherein the flexible arms arch outwardly away from one another at the grip portion of the carrying handle and then extend downwardly and inwardly toward one another at the distal ends; and a clamping ring joined to the distal ends of the first and second flexible arms, the clamping ring being configured to clamp about a neck portion of the enclosure near the retaining clip such that the retaining clip is located in between the end of the enclosure and the clamping ring, the clamping ring defining an inner space for receiving the neck portion of the enclosure, the clamping ring having an inner surface that comes into contact with the neck portion when the neck portion is received in the inner space defined by the clamping ring, the inner surface of the clamping ring having one or more protrusions thereon that grip an outer surface of the neck portion when the neck portion is within the inner space defined by the clamping ring.

In one embodiment the gripping portion of the carrying handle is adapted for receiving at least first and second fingers of a user. In another embodiment, the gripping portion comprises at least first and second arches that are adapted to receive the first and second fingers, respectively.

In another embodiment, said one or more protrusions comprise a plurality of protrusions having equal sizes and shapes. In another embodiment, adjacent protrusions of said plurality of protrusions are separated from one another by a predetermined distance. In yet another embodiment, said one or more protrusions grip an outer surface of the neck portion to help prevent the outer surface of the neck portion from rotating relative to the inner surface of the clamping ring.

In another embodiment, said one or more protrusions comprise a plurality of protrusions, each protrusion being substantially rectangular in shape. In yet another embodiment, said one or more protrusions comprise a plurality of spikes. In still another embodiment, said one or more protrusions comprise a plurality of ridges. In a further embodiment, said one or more protrusions comprise a plurality barbs. In an additional embodiment, said one or more protrusions comprise a plurality hooks. In still another embodiment, said one or more protrusions comprise a plurality burrs.

In another embodiment, each of the flexible arms branches into first and second arm branches as the distal ends of the first and second flexible arms approach the clamping ring, the second arm branches extending toward one another as the second arm branches approach the clamping ring to define a gap through which the neck portion is pressed into the inner space defined by the clamping ring, the second arm branches being configured to flex outwardly as the neck portion is pressed through the gap into the inner space defined by the clamping ring and to return to unflexed states once the neck portion is fully within the clamping ring.

In still another embodiment, the top end of the carrying handle has a strengthening element thereon comprising a region of increased thickness where the proximal ends of the first and second flexible arms are joined to form the gripping portion, and wherein the increased thickness increases a strength of the gripping portion of the carrying handle.

Another embodiment of the invention is a carrying handle for use in conjunction with food items that have been wrapped or bagged in an enclosure having an end that is closed with a retaining clip, the carrying handle comprising first and second flexible arms having proximal ends and distal ends, the proximal ends being joined together at a top end of the carrying handle to form a grip portion, wherein the flexible arms arch outwardly away from one another at the grip portion of the carrying handle and then extend downwardly and inwardly toward one another at the distal ends; a strengthening element disposed on the top end of the carrying handle, the strengthening element comprising a region of increased thickness where the proximal ends of the first and second flexible arms are joined to form the gripping portion, wherein the increased thickness increases a strength of the gripping portion of the carrying handle; and a clamping ring joined to the distal ends of the first and second flexible arms, the clamping ring being configured to clamp about a neck portion of the enclosure near the retaining clip such that the retaining clip is located in between the end of the enclosure and the clamping ring, the clamping ring defining an inner space for receiving the neck portion of the enclosure, the clamping ring having an inner surface that comes into contact with the neck portion when the neck portion is received in the inner space defined by the clamping ring.

In yet another embodiment the inner surface of the clamping ring has one or more protrusions thereon that grip an outer surface of the neck portion when the neck portion is within the inner space defined by the clamping ring. In still another embodiment, the protrusions comprise at least one of spikes, ridges, barbs, hooks, and burrs.

In a further embodiment, the gripping portion comprises at least first and second arches adapted to receive the first and second fingers, respectively.

Another embodiment of the invention is a method of making a carrying handle for use in conjunction with food items that have been wrapped or bagged in an enclosure having an end that is closed with a retaining clip, the method comprising providing a mold having a first region for forming a clamping ring at a bottom end of the carrying handle, the mold having second and third regions for forming first and second flexible arms, respectively, the mold having a fourth region for forming a strengthening element at a top end of the carrying handle; injecting a fluid molding material into the first region such that the fluid molding material flows from the first region into the second and third regions and then flows from the second and third regions into the fourth region, wherein the strengthening element is formed where fluid molding material flowing from the second region into the fourth region comes into contact with fluid molding material flowing from the third region into the fourth region; and curing the fluid molding material to convert the fluid molding material into hardened molding material.

In another embodiment of this method the strengthening element comprises a region of increased thickness at the top end of the carrying handle.

These and other features and advantages will become apparent from the following description, drawings and claims.

### BRIEF DESCRIPTION OF THE DRAWINGS

The figures are not necessarily drawn to scale unless specifically stated below in the Detailed Description to be drawn to scale. Like reference numerals in the figures represent like elements or features.

FIG. 1 is a front perspective view of the carrying handle in accordance with a representative embodiment.

FIG. 2 is a front perspective view of the carrying handle in accordance with another representative embodiment.

FIG. 3 is a back perspective view of the carrying handle shown in FIG. 2.

FIG. 4 is a right-side perspective view of the carrying handle shown in FIG. 2.

FIG. 5 is a top end perspective view of the carrying handle shown in FIG. 2.

FIG. 6 is a left-side perspective view of the carrying handle shown in FIG. 2 attached to a bag or shrink wrap, wherein a clamping ring of the carrying handle is clamped about a neck portion of the bag or shrink wrap adjacent a retaining clip that is used to close the end of the bag or shrink wrap.

FIG. 7 is an enlarged front perspective view of the clamping ring of the carrying handle shown in FIGS. 2-6.

FIG. 8 is a flow diagram representing the method for making the carrying handle to include the strengthening element 20 shown in FIG. 1 via a plastic injection molding process.

### DETAILED DESCRIPTION OF PREFERRED EMBODIMENTS

The present disclosure is directed to embodiments of improved carrying handles for carrying bagged or shrink-wrapped food items that can have, among other advantages, increased strength, improvements in terms of facilitating carrying by a user, twist prevention to prevent a clamping ring of the carrying handle from twisting relative to a neck portion of the bag or shrink wrap after the handle has been attached to the bag or shrink wrap, slip prevention to prevent the carrying handle from sliding upwards along the neck of the bag, and a stronger and safer all-around bag and handle combination. Various embodiments for achieving these and other goals and advantages are described below with reference to the figures.

In the following detailed description, a few nonlimiting exemplary, or representative, embodiments are described to demonstrate the inventive principles and concepts. For purposes of explanation and not limitation, representative embodiments disclosing specific details are set forth in order to provide a thorough understanding of an embodiment according to the present disclosure. However, it will be apparent to one having ordinary skill in the art having the benefit of the present disclosure that other embodiments that depart from the specific details disclosed herein remain within the scope of the appended claims. Moreover, descriptions of well-known apparatuses and methods may be omitted so as to not obscure the description of the representative embodiments. Such methods and apparatuses are clearly within the scope of the present disclosure.

The terminology used herein is for purposes of describing particular embodiments only and is not intended to be limiting. The defined terms are in addition to the technical and scientific meanings of the defined terms as commonly understood and accepted in the technical field of the present teachings.

As used in the specification and appended claims, the terms “a,” “an,” and “the” include both singular and plural referents, unless the context clearly dictates otherwise. Thus, for example, “a device” includes one device and plural devices.

Relative terms may be used to describe the various elements' relationships to one another, as illustrated in the accompanying drawings. These relative terms are intended to encompass different orientations of the device and/or elements in addition to the orientation depicted in the drawings. For example, terms such as “over,” “above,” “below,” “top,” “bottom,” “upper” and “lower” may be used to describe the various elements' relationships to one another, as illustrated in the accompanying drawings. These relative terms are intended to encompass different orientations of the device and/or elements in addition to the orientation depicted in the drawings. For example, if the device were inverted with respect to the view in the drawings, an element described as “above” another element, for example, would now be below that element.

The terms “substantial” or “substantially” mean to within acceptable limits or degrees acceptable to those of skill in the art. For example, the term “substantially parallel to” means that a structure or device may not be made perfectly parallel to some other structure or device due to tolerances or imperfections in the process by which the structures or devices are made. The term “approximately” means to within an acceptable limit or amount to one of ordinary skill in the art.

Where a first device is said to be connected or coupled to a second device, this encompasses examples where one or more intermediate devices may be employed to connect the two devices to each other. In contrast, where a first device is said to be directly connected or directly coupled to a second device, this encompasses examples where the two devices are connected together without any intervening devices other than electrical connectors (e.g., wires, bonding materials, etc.).

Exemplary, or representative, embodiments will now be described with reference to the figures, in which like reference numerals represent like components, elements or features. It should be noted that features, elements or components in the figures are not intended to be drawn to scale, emphasis being placed instead on demonstrating inventive principles and concepts.

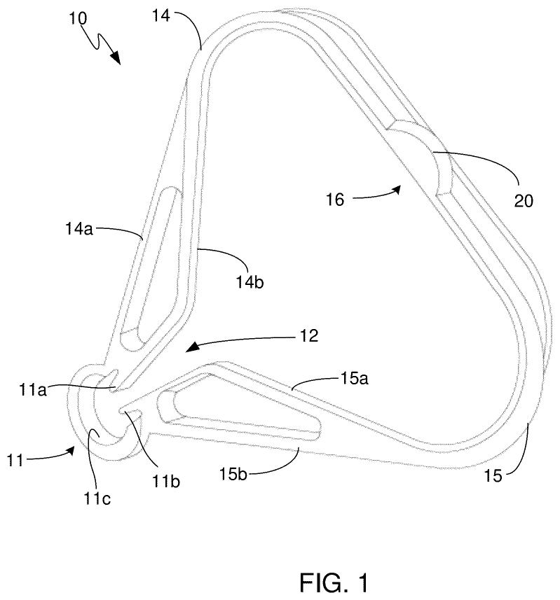

FIG. 1 is a front perspective view of the carrying handle 10 in accordance with a representative embodiment. In accordance with the representative embodiment shown in FIG. 1, the carrying handle 10 comprises first and second flexible arms 14 and 15, respectively, having proximal ends that meet and are joined together at a top end of the carrying handle 10 and distal ends that meet and are joined with a clamping ring 11 at a bottom end of the carrying handle 10. From the top end of the carrying handle 10 where the proximal ends of the flexible arms 14 and 15 meet and are joined together, the flexible arms 14 and 15 extend substantially linearly away from one another, arch outwardly away from one another and then extend downwardly and inwardly toward one another as their distal ends approach the clamping ring 11.

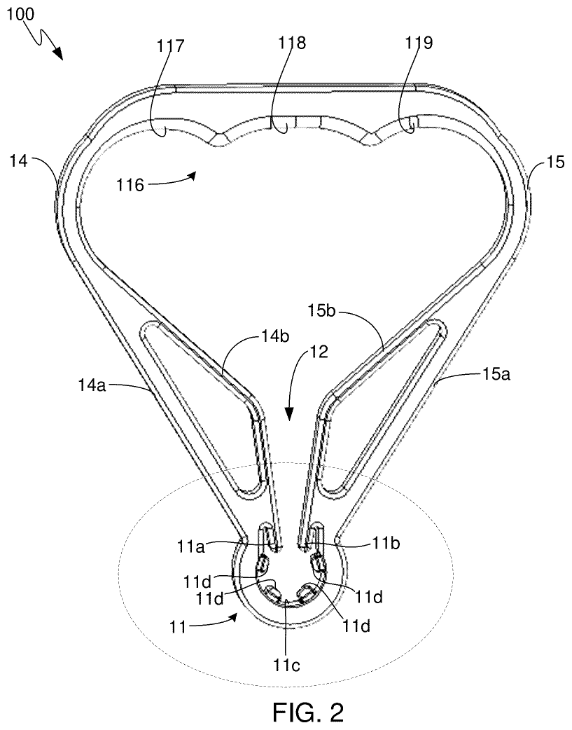

At the top end of the carrying handle 10 where the proximal ends of the flexible arms 14 and 15 meet and are joined together, the flexible arms 14 and 15 form a gripping portion 16 adapted or configured for a user to grip the carrying handle 10. As will be described below in more detail with FIGS. 2-7, the gripping portion 16 can be defined by two or three arches that are wide enough to receive two or three fingers, respectively, of a user's hand (not shown).

As the flexible arms 14 and 15 extend downwardly and inwardly toward one another as their distal ends approach the clamping ring 11, the arms 14 and 15 branch into first arm branches 14a and 15a, respectively, and second arm branches 14b and 15b, respectively. The second arm branches 14b and 15b extend inwardly more than the first arm branches 14a and 15a, respectively, and then extend downwardly to meet and join the ends 11a and 11b, respectively, of the clamping ring 11. The downward and inward directions of the second arm branches 14b and 15b and the ends 11a and 11b of the clamping ring 11 define a gap 12. It can be seen in FIG. 1 that the portion of the gap 12 defined by the downward and inward directions of the second arm branches 14b and 15b increasingly narrows as the distal ends of the arms 14 and 15 approach the clamping ring 11. This increase in the narrowing of the gap 12 causes the neck portion of the bag (not shown) to be increasingly compressed as the neck portion is pushed downwardly through the gap 12 into the inner space defined by the clamping ring 11.

The arm branches 14b and 15b flex outwardly away from one another as the neck portion of the bag is inserted into the gap 12. The arm branches 14b and 15b flex back to their unflexed positions once the neck portion is fully within the inner space defined by the clamping ring 11. Once inside the inner space defined by the clamping ring 11, the neck portion of the bag decompresses slightly and expands outwardly against an inner surface 11c of the clamping ring 11. As will be described below in more detail with reference to FIGS. 2-7, the inner surface 11c can have protrusions thereon that are configured to grip the neck portion of the bag to prevent the carrying handle 10 from sliding or twisting relative to the neck portion of the bag after the carrying handle 10 has been attached to the bag.

The carry handle 10 preferably is made as unitary, or integrally-formed, piece part via a plastic injection molding process. In accordance with the representative embodiment shown in FIG. 1, the plastic molding material is introduced into the mold at the portion of the mold that forms the clamping ring 11 of the carrying handle 10. This causes the molding material to flow from the region of the mold that forms the clamping ring 11, through the portions of the mold that form the arms 14 and 15 and finally into the portion of the mold that forms the gripping portion 16 where the proximal ends of the flexible arms 14 and 15 are joined together. The result of these flows merging at the top end of the handle 10 is that a strengthening element 20 is formed due to extra molding material pooling and then hardening at this location at the top end of the carrying handle 10. The strengthening element 20 adds strength to the top end of the carrying handle 10 to ensure that the carrying handle 10 does not break when being used to carry heavier food items.

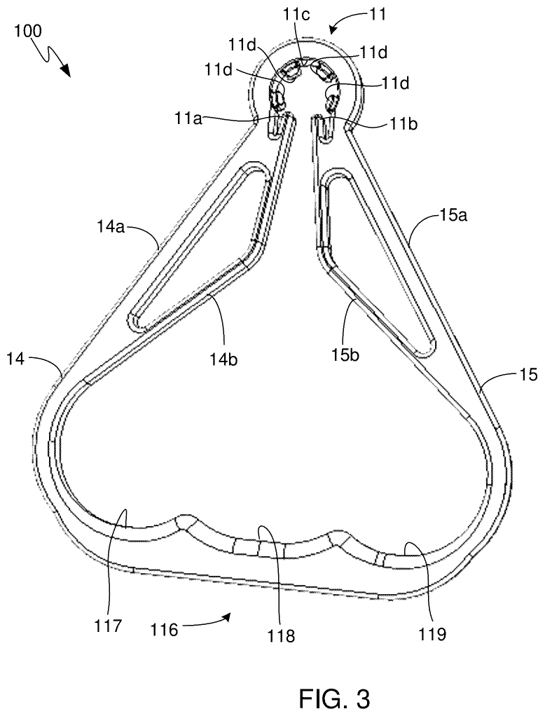

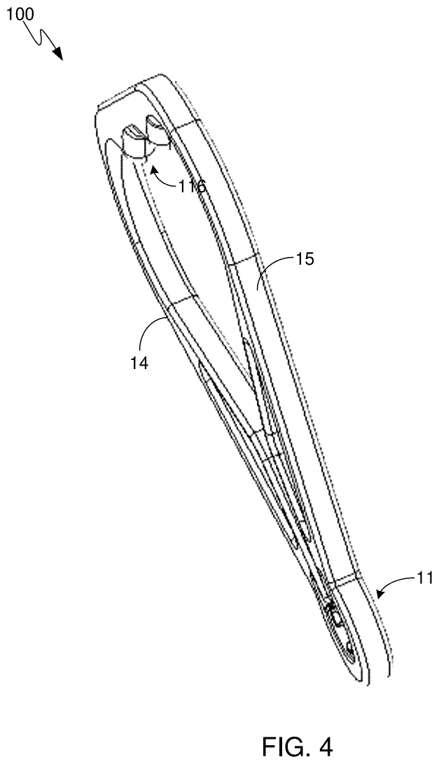

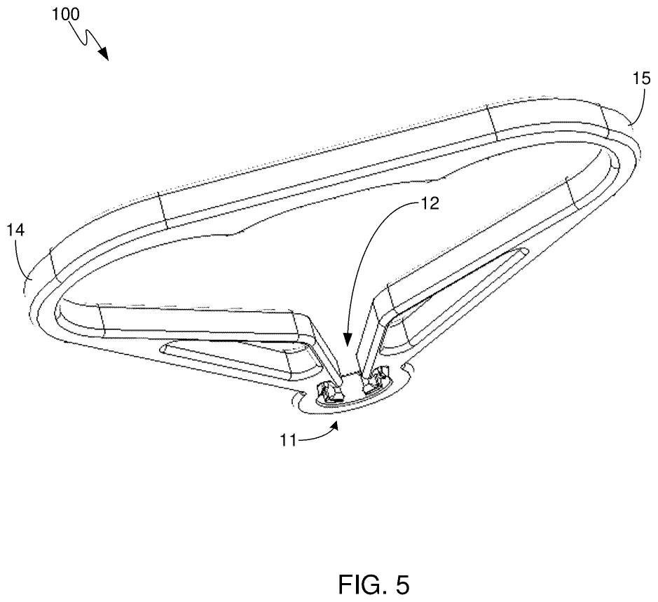

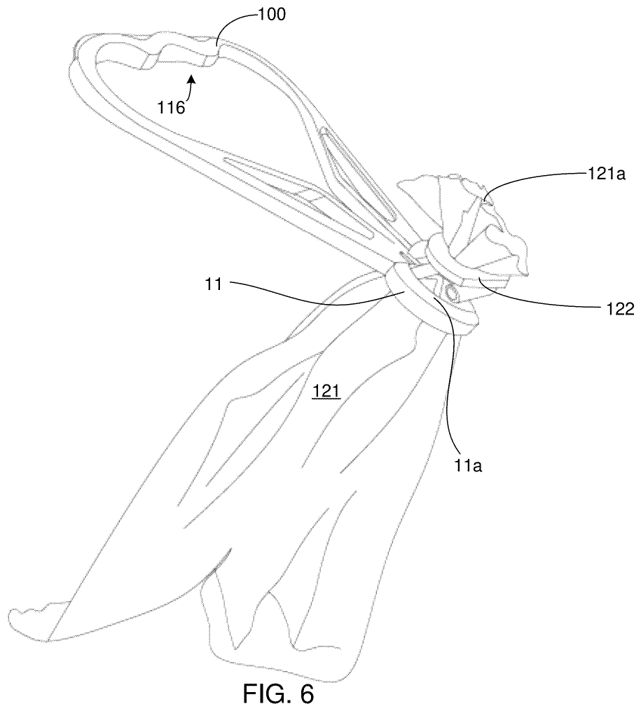

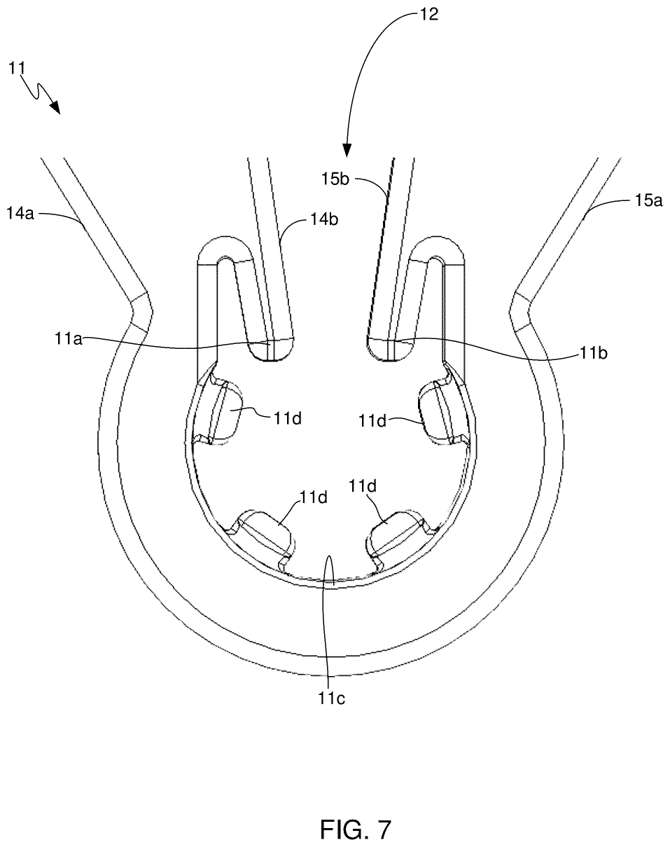

FIG. 2 is a front perspective view of the carrying handle 100 in accordance with another representative embodiment. FIG. 3 is a back perspective view of the carrying handle 100 shown in FIG. 2. FIG. 4 is a right-side perspective view of the carrying handle 100 shown in FIG. 2. FIG. 5 is a top end perspective view of the carrying handle 100 shown in FIG. 2. FIG. 6 is a left-side perspective view of the carrying handle 100 shown in FIG. 2 attached to a bag or shrink wrap 121 with a clamping ring 111 of the carrying handle 100 clamped about a neck portion of the bag or shrink wrap 121 adjacent to a retaining clip 122 that is used to close the end of the bag or shrink wrap 121. FIG. 7 is an enlarged front perspective view of the clamping ring 111 of the carrying handle 100 shown in FIGS. 2-6.

With reference to FIGS. 2-7, a carrying handle indicated generally as 100 is shown for use in carrying food items such as, for example, a whole bodied turkey that has been bagged or wrapped, as by shrink wrapping, in a bag or shrink wrap 121 having retaining clip 122 (FIG. 6) secured thereto. The retaining clip 122 is a known device that is used to close the end of the bag or shrink wrap 121. For ease of discussion, the bag or shrink wrap 121 will be referred to hereinafter simply as bag 121, but it should be noted that the inventive principles and concepts are not limited to any particular type of bag, shrink wrap or other enclosure that is used for enclosing food items.

When the carrying handle 100 is attached to the bag 121 as shown in FIG. 6, the retaining clip 122 is located in between a front surface 11a of the clamping ring 11 and the proximal end 121a of the bag 21. The clamping ring 11 of the carrying handle 100 comprises a generally elliptically-shaped or circularly-shaped ring with inwardly-and downwardly-directed ends 11b and 11c (FIGS. 2 and 7) that are spaced apart from one another to define the gap 12 through which a neck portion of the bag 121 near its proximal end 121a (FIG. 6) can pass. The gap 12 is narrower than the neck portion of the bag 121 such that when the neck portion of the bag 121 is pushed through the inwardly-and downwardly-directed ends 11a and 11b into the inner space defined by the clamping ring 11, the pushing pressure compresses the neck portion of the bag 121. The inner space defined by the clamping ring 11 is wider than the gap 12. Therefore, once the compressed neck portion of the bag 121 is fully within the inner space defined by the clamping ring 111, the resilient nature of the material of which the bag 121 is made (e.g., plastic) causes the neck portion of the bag 121 to expand outwardly and press against the inner surface 11c of the clamping ring 11.

In accordance with a preferred embodiment, the inner surface 11c (FIGS. 2 and 7) of the clamping ring 11 has protrusions 11d protruding therefrom in directions generally toward the center of the inner space defined by the clamping ring 11. When the neck portion of the bag 121 expands outwardly and presses against the inner surface 11c of the clamping ring 11, the protrusions 11d press into and tightly grip the outer surface of the neck portion of the bag 121. This gripping action prevents the carrying handle 100 from sliding, rotating, or twisting relative to the neck portion of the bag 121 and generally holds it in position relative to the neck portion of the bag 121 once the carrying handle 100 has been attached to the bag 121 as shown in FIG. 6.

In accordance with the representative embodiment shown in FIGS. 2-7, the carrying handle 100 comprises the first and second flexible arms 14 and 15, respectively, having proximal ends that meet and are joined together at a top end of the carrying handle 100 and distal ends that meet and are joined with the clamping ring 11 at a bottom end of the carrying handle 100. From the top end of the carrying handle 100 where the proximal ends of the flexible arms 14 and 15 meet and are joined with one another, the flexible arms 14 and 15 extend substantially linearly away from one another, arch outwardly away from one another and then extend downwardly and inwardly toward one another as their distal ends approach the clamping ring 11.

In a normal carrying position, the bag 121 contains a product such as a poultry carcass in a main portion of the bag 121, with the retaining clip 122 between the main portion of the bag 121 and the proximal end 121a of the bag 121. Typically, when a consumer handles the bag 121, the consumer will grab the bag 121 near the proximal end 121a of the bag 121, generally at or proximal to the retaining clip 122. In this manner, when a consumer lifts the bag 121 containing the product, the main portion of the bag 121 will hang downwards, with the proximal end 121a of the bag 121 being in an upwards orientation, and the carrying handle 100 will be pulled towards the retaining clip 122 and the proximal end 121a of the bag 121. Also in this manner, when a consumer grabs the carrying handle 100 of a bag 121 lying in almost any orientation and pulls the carrying handle 100 in most directions, the carrying handle 100 will be pulled towards the retaining clip 122 and the proximal end 121a of the bag 121. Thus, in this manner, when the carrying handle 100 is placed on the bag 121 such that the retaining clip 122 is between the carrying handle 100 and the proximal end 121a of the bag 121, the protrusions 11d prevent the carrying handle 100 from sliding towards the retaining clip 122 and/or from sliding and pushing or otherwise forcing the retaining clip 122 towards the proximal end 121a of the bag 121.

One nonlimiting advantage of having the protrusions 11d or other rough areas of carrying handle 100 in the inner surface 11c of the clamping ring 11 is to prevent the carrying handle 100 from slipping towards the retaining clip 122 and/or causing the retaining clip 122 to be forced upwards on the bag 121 towards and potentially off of the proximal end 121a of the bag 121. As one cannot be assured that the retaining clip 122 is securely mounted on the bag 121, preventing the carrying handle 100 from being forced against the retaining clip 122 is a benefit as if the retaining clip 122 is loose, then if the carrying handle 100 slides towards the retaining clip 122 when a consumer pulls on or lifts the carrying handle 100, then the carrying handle 100 can push the retaining clip 122 off of the bag 121. The bag 122 will drop, the retaining clip 122 will no longer be on the bag 121, and the bag 121 will be unsealed. The dropped bag 122 may open, spilling and spoliating the contents. The dropped bag 122 also may land on the foot of the consumer/carrying person or another person, which could cause an injury, especially if the bag 122 contained a frozen and/or relatively heavy item. Thus, the protrusions 11d in the clamping ring 11 help keep the carrying handle 100 on the bag 100 and help prevent pushing the retaining clip 122 off of the bag 121. In other words, the protrusions 11d allow for the carrying handle 100 to grab on to the bag 121 and hold the bag 121, and prevent the carrying handle 100 from sliding and putting pressure on the retaining clip 122.

As can be seen in FIG. 6, the retaining clip 122 can be a rod-like piece of metal twisted into a circle with overlapping ends. Being metal, or other materials that are hard relative to the material of the bag 121, these ends of the retaining clip 122 have the potential of being able to tear the material of the bag 121. As such, after the retaining clip 122 is placed on the bag and secured, if the retaining clip 122 is forced or pressured into the material of the bag 121, the ends of the retaining clip 122 may tear or otherwise damage the bag 121, causing the bag 121 to fail or to be compromised. This can result in the bag 121 ripping and the contents of the bag 121 falling out of the bag 121, or the product in the bag 121 being exposed to the ambient causing the contamination of the product in the bag 121.

To help prevent the retaining clip 122 from causing damage to the bag 122, as shown in FIG. 6, the carrying handle 100 preferably is placed on the bag 121 such that the ends of the retaining clip 122 are opposite the gripping portion 116 of the carrying handle 100. In this position, even if the carrying handle 100 is touching or slides up to touch the retaining clip 122, when the carrying handle 100 is lifted, the clamping ring 11 does not force the ends of the retaining clip 122 into the bag 121, which can tear or otherwise damage the bag 121. In this manner, the protrusions 11d prevent the carrying handle 100 from rotating to a position where the ends of the retaining clip 122 and the gripping portion 116 are on the same side of the bag 121, which could result in the clamping ring 11 contacting the ends of the retaining clip 122 and forcing the ends of it into the bag 121, which could tear it.

The protrusions 11d of the clamping ring 11 of the carrying handle 100 of the present disclosure prevent this problem from occurring. When the carrying handle 100 is used to lift the food item, the weight of the food item pulls the bag 121 in the downward direction toward the floor, which causes the gap 12 to tilt toward the retaining clip 122. The force of the protrusions 11d pressing into the neck portion of the bag 121 prevents the surface 11a of the clamping ring 11 from pressing against the retaining clip 22 and potentially causing its ends to tear the bag 121.

Thus, having the protrusions 11d on the inner surface of the clamping ring 11a provides three-fold advantage—one, preventing rotation and sliding of the carrying handle 100 so that there is less pressure on the retaining clip 122 to keep any sharp ends or points of the retaining clip 122 from ripping the bag 121; two, preventing sliding of the carrying handle 100 so as to keep the carrying handle 100 from forcing the retaining clip 122 off of the bag 121; and three, adding the functionality of allowing a consumer to lift the bag 121 more easily than just grabbing the proximal end 121a of the bag 121.

With reference again to FIG. 2, at the top end of the carrying handle 100 where the proximal ends of the flexible arms 14 and 15 meet and are joined with one another, the flexible arms 14 and 15 form the gripping portion 116, which is adapted or configured for a user to grip the carrying handle 100. Preferably, the gripping portion 116 is defined by three arches 117, 118 and 119 that are wide enough to receive an index finger, a middle finger and a ring finger, respectively, of a user's hand (not shown). The gripping portion 116 can have fewer than three arches.

In FIG. 7, the protrusions 11d are shown as being rectangular elements having a predetermined height and spaced apart from one another by a predetermined distance. However, as will be understood by those of skill in the art in view of the description provided herein, the protrusions 11d can have any suitable configuration for accomplishing the gripping goal described above to prevent twisting of the clamping ring 11 relative to the neck portion of the bag 121. For example, the protrusions 11d can comprise spikes, ridges, barbs, hooks, burrs, or any configuration that suitably grips the neck portion of the bag 121 when the neck portion is within the inner space defined by the clamping ring 11.

The preferred material for the carrying handles 10 and 100 is nylon with a thickness of up to approximately 0.30 inches, and preferably between 0.03 and 0.15 inches. This thickness range provides sufficient rigidity for carrying handle while permitting the resilient components of carrying handle to be adequately deformable via their narrow cross-section. Plastics and other polymers also are suitable and can be selected by those of ordinary skill in the art based on the use of carrying handle.

It should be noted that the gripping portion 16 of the carrying handle 10 shown in FIG. 1 can be modified to include the arches 17, 18 and 19 of the gripping handle 10. Likewise, the inner surface 11c of the clamping ring 11 of the carrying handle 10 shown in FIG. 1 can be modified to include the protrusions 11d of the carrying handle 100 shown in FIGS. 2-7. Likewise, the carrying handle 100 shown in FIGS. 2-7 can be modified to include the strengthening element 20 of the carrying handle 10 shown in FIG. 1. Like the carrying handle 10, the carrying handle 100 preferably is made as unitary, or integrally-formed, piece part via a plastic injection molding process.

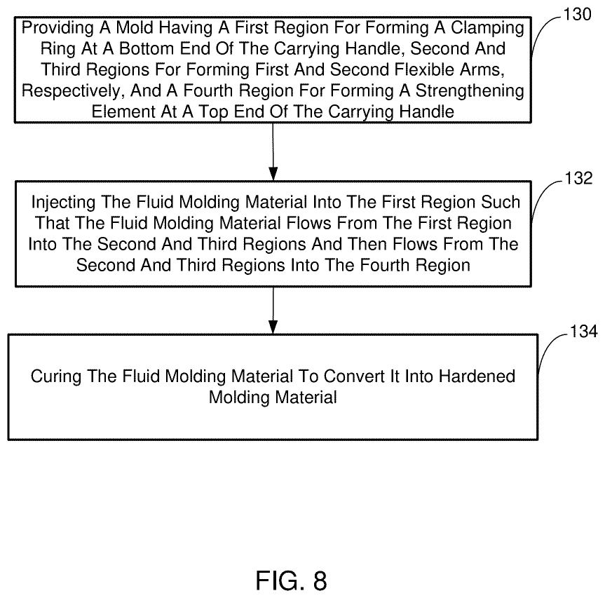

FIG. 8 is a flow diagram representing the method for making the carrying handle to include the strengthening element 20 shown in FIG. 1 via a plastic injection molding process. Block 130 represents the step of providing a mold having a first region for forming a clamping ring at a bottom end of the carrying handle, second and third regions for forming first and second flexible arms, respectively, and a fourth region for forming a strengthening element at a top end of the carrying handle. Block 132 represents the process step of injecting a fluid molding material into the first region such that the fluid molding material flows from the first region into the second and third regions and then flows from the second and third regions into the fourth region. The strengthening element is formed where fluid molding material flows from the second region into the fourth region comes into contact with fluid molding material flowing from the third region into the fourth region. Block 134 represents curing the fluid molding material to convert the fluid molding material into hardened molding material.

It should be noted that the method can include steps or processes in addition to those shown in FIG. 8 and/or that are different from those shown in FIG. 8. It should also be noted that processes other than injection molding can be used to manufacture the carrying handle, as will be understood by those of skill in the art in view of the description provided herein.

The foregoing detailed description of the preferred embodiments and the appended figures have been presented only for illustrative and descriptive purposes. They are not intended to be exhaustive and are not intended to limit the scope of the present disclosure. The embodiments described herein were selected and described to best explain the principles of the invention and its practical applications. One of skill in the art will recognize that many variations can be made to the carrying handle disclosed in this specification without departing from the scope of the invention.

What is claimed is:

1. A carrying handle for use in conjunction with food items that have been wrapped or bagged in an enclosure having an end that is closed with a retaining clip, the carrying handle comprising:
first and second flexible arms having proximal ends and distal ends, the proximal ends being joined together at a top end of the carrying handle to form a grip portion, wherein the flexible arms arch outwardly away from one another at the grip portion of the carrying handle and then extend downwardly and inwardly toward one another at the distal ends; and
a clamping ring joined to the distal ends of the first and second flexible arms, the clamping ring being configured to clamp about a neck portion of the enclosure near the retaining clip such that the retaining clip is located in between the end of the enclosure and the clamping ring, the clamping ring defining an inner space for receiving the neck portion of the enclosure, the clamping ring having an inner surface that comes into contact with the neck portion when the neck portion is received in the inner space defined by the clamping ring, the inner surface of the clamping ring having one or more protrusions thereon that grip an outer surface of the neck portion when the neck portion is within the inner space defined by the clamping ring.

2. The carrying handle of claim 1, wherein the gripping portion of the carrying handle is adapted for receiving at least first and second fingers of a user.

3. The carrying handle of claim 2, wherein the gripping portion comprises at least first and second arches that are adapted to receive the first and second fingers, respectively.

4. The carrying handle of claim 1, wherein said one or more protrusions comprise a plurality of protrusions having equal sizes and shapes.

5. The carrying handle of claim 4, wherein adjacent protrusions of said plurality of protrusions are separated from one another by a predetermined distance.

6. The carrying handle of claim 1, wherein said one or more protrusions grip an outer surface of the neck portion to help prevent the outer surface of the neck portion from rotating relative to the inner surface of the clamping ring.

7. The carrying handle of claim 6, wherein said one or more protrusions comprise a plurality of protrusions, each protrusion being substantially rectangular in shape.

8. The carrying handle of claim 6, where said one or more protrusions comprise a plurality of spikes.

9. The carrying handle of claim 6, where said one or more protrusions comprise a plurality of ridges.

10. The carrying handle of claim 6, where said one or more protrusions comprise a plurality barbs.

11. The carrying handle of claim 6, where said one or more protrusions comprise a plurality hooks.

12. The carrying handle of claim 6, where said one or more protrusions comprise a plurality burrs.

13. The carrying handle of claim 1, wherein each of the flexible arms branches into first and second arm branches as the distal ends of the first and second flexible arms approach the clamping ring, the second arm branches extending toward one another as the second arm branches approach the clamping ring to define a gap through which the neck portion is pressed into the inner space defined by the clamping ring, the second arm branches being configured to flex outwardly as the neck portion is pressed through the gap into the inner space defined by the clamping ring and to return to unflexed states once the neck portion is fully within the clamping ring.

14. The carrying handle of claim 1, wherein the top end of the carrying handle has a strengthening element thereon comprising a region of increased thickness where the proximal ends of the first and second flexible arms are joined to form the gripping portion, and wherein the increased thickness increases a strength of the gripping portion of the carrying handle.

15. A carrying handle for use in conjunction with food items that have been wrapped or bagged in an enclosure having an end that is closed with a retaining clip, the carrying handle comprising:
first and second flexible arms having proximal ends and distal ends, the proximal ends being joined together at a top end of the carrying handle to form a grip portion, wherein the flexible arms arch outwardly away from one another at the grip portion of the carrying handle and then extend downwardly and inwardly toward one another at the distal ends;
a strengthening element disposed on the top end of the carrying handle, the strengthening element comprising a region of increased thickness where the proximal ends of the first and second flexible arms are joined to form the gripping portion, wherein the increased thickness increases a strength of the gripping portion of the carrying handle; and
a clamping ring joined to the distal ends of the first and second flexible arms, the clamping ring being configured to clamp about a neck portion of the enclosure near the retaining clip such that the retaining clip is located in between the end of the enclosure and the clamping ring, the clamping ring defining an inner space for receiving the neck portion of the enclosure, the clamping ring having an inner surface that comes into contact with the neck portion when the neck portion is received in the inner space defined by the clamping ring.

16. The carrying handle of claim 15, wherein the inner surface of the clamping ring has one or more protrusions thereon that grip an outer surface of the neck portion when the neck portion is within the inner space defined by the clamping ring.

17. The carrying handle of claim 16, wherein the protrusions comprise at least one of spikes, ridges, barbs, hooks, and burrs.

18. The carrying handle of claim 15, wherein the gripping portion comprises at least first and second arches adapted to receive the first and second fingers, respectively.

19. A method of making a carrying handle for use in conjunction with food items that have been wrapped or bagged in an enclosure having an end that is closed with a retaining clip, the method comprising:
providing a mold having a first region for forming a clamping ring at a bottom end of the carrying handle, the mold having second and third regions for forming first and second flexible arms, respectively, the mold having a fourth region for forming a strengthening element at a top end of the carrying handle;
injecting a fluid molding material into the first region such that the fluid molding material flows from the first region into the second and third regions and then flows from the second and third regions into the fourth region, wherein the strengthening element is formed where fluid molding material flowing from the second region into the fourth region comes into contact with fluid molding material flowing from the third region into the fourth region; and
curing the fluid molding material to convert the fluid molding material into hardened molding material.

20. The method of claim 19, wherein the strengthening element comprises a region of increased thickness at the top end of the carrying handle.
